(19) United States
(12) Patent Application Publication
(10) Pub. No.: US 2025/0327590 A1
(43) Pub. Date: Oct. 23, 2025

(54) FILTER FAN UNIT

(71) Applicant: MANN+HUMMEL LIFE SCIENCES & ENVIRONMENT HOLDING SINGAPORE PTE. LTD., Singapore (SG)

(72) Inventors: Milad ALZAGHARI, Wuppertal (DE); Frank SPEHL, Neuss (DE); Franco CATALANO, Nagold (DE); Santosh KALYANASUNDARAM, Hosur (IN); Ritesh ANISH, Bangalore (IN)

(21) Appl. No.: 19/176,997

(22) Filed: Apr. 11, 2025

(30) Foreign Application Priority Data
Apr. 18, 2024 (IN) 202441031113

(51) Int. Cl. F24F 7/003; B01D 46/00; B01D 46/42; F24F 3/167

(52) U.S. Cl. CPC F24F 7/003; B01D 46/0043; B01D 46/4236; B01D 2273/30; F24F 3/167; F24F 2221/14

(57) ABSTRACT

A filter fan unit includes a housing, a fan configured to generate an air flow from an air inlet to an air outlet, and a filter at the air outlet. An opening for the fan and side walls extend from an air inlet plane towards the air outlet. An angle between a first side wall and the air inlet plane and an angle between a second side wall and the air inlet plane is greater than 90° so that the first and second side walls diverge in the direction of the air outlet. A perforated plate arranged between the fan and the air outlet extends substantially parallel to the air inlet plane. A first end edge of the plate and the first side wall are spaced apart from each other and a second end edge of the plate and the second side wall are spaced apart from each other.

### CROSS-REFERENCE TO RELATED APPLICATIONS

This application claims the benefit of Indian Application No. 202441031113 filed on Apr. 18, 2024, the entire contents of which is incorporated herein by reference.

### TECHNICAL FIELD

The invention relates to a filter fan unit.

### BACKGROUND

EP 1 798 492 A2 discloses a filter fan unit that may be used in the ceiling of a clean room. The filter fan unit includes a housing and a fan arranged in the housing. The fan is used to generate an air flow from an air inlet to an air outlet of the housing. Furthermore, the filter fan unit includes a filter that is arranged at the air outlet. Air flows through the filter fan unit from the ceiling into the cleanroom and is extracted from the cleanroom close to the floor of the cleanroom.

The housing of the filter fan unit of EP 1 798 492 A2 has an opening for the fan and four side walls. The side walls extend from an air inlet plane, in which the opening is located, in the direction of the air outlet. An angle between the first side wall and the air inlet plane and an angle between a second side wall opposite the first side wall and the air inlet plane are each greater than 90°, so that the first side wall and the second side wall diverge in the direction of the air outlet.

The operation of the filter fan unit causes noise that should be kept as low as possible. Undesirably high air speeds and turbulences in the fan and housing are the cause of an increased noise level which is also usually accompanied by higher energy consumption of the fan. Although the air flow through the housing may be optimized through a special design of the housing and fan, this usually leads to a more complex structure and higher manufacturing costs for the filter fan unit. When used in a ceiling system, the weight of the filter fan unit must also not be too great.

### SUMMARY

The invention is based on the object to provide a filter fan unit that is manufactured cost-effectively, is lightweight and operates efficiently and quietly.

The object is solved by a filter fan unit according to the invention. Embodiments of the invention are described hereafter and shown in the accompanying drawings.

According to the invention, a perforated plate is arranged between the fan and the air outlet, wherein the perforated plate extends substantially parallel to the air inlet plane, wherein a first end edge of the plate and the first side wall are spaced apart from each other and wherein a second end edge of the plate and the second side wall are spaced apart from each other.

The perforated plate and its arrangement between the first side wall and the second side wall results in a homogenous air distribution throughout the filter fan unit, and therefore an optimum utilisation of the filter. Over the entire surface of the filter or over very large parts of the surface of the filter, the flow velocity through the filter is almost the same. The efficient use of the filter means that the power of the fan and the flow velocities in the housing may be kept comparatively low, which reduces noise emissions and saves energy.

The free space or gap between the first end edge of the perforated plate and the first side wall allows the air to reach the filter unhindered. A flow through the perforated plate is also possible, but in contrast to the flow through the gap, it is associated with a certain flow resistance. The flow resistance depends on the design and number of openings in the perforated plate. The larger the cumulative area of the openings in relation to the total area of the plate is, the lower the flow loss is when flowing through the plate.

For the gap between the second end edge of the perforated plate and the second side wall and for the flow conditions through this gap, the explanations above apply accordingly. In an embodiment, the filter fan unit has an axially symmetrical structure. In this case, the gap between the first end edge of the plate and the first side wall corresponds in size and shape to the gap between the second end edge of the plate and the second side wall.

The filter may comprise a particle filter medium, such as a HEPA filter medium. The filter media may have one or more layers. The one or more layers may comprise different filter media. The filter media may be non-pleated, such as a filter mat, or pleated. The filter media may be made of synthetic and/or naturally occurring polymers. The filter media may be made of a spunbonded material, for example a polyethylene terephthalate or polypropylene spunbonded material, and/or a needlebonded material, for example a polypropylene or polyethylene terephthalate needlebonded material, and/or a meltblown layer and/or a multicomponent fiber material, for example comprising bicomponent fibers with a polypropylene/polyacrylonitrile component.

The filter may be in the form of a panel filter. The panel filter may have a flat base surface, which extends parallel to the perforated plate. The filter may comprise one or more panel filters. Where the filter includes more than one panel filter, the panel filters may be arranged in a V-shape relative to one another in order to maximize filter area.

In one embodiment, the housing has a rectangular cover, which is located in the air inlet plane and which delimits the opening for the fan. The cover, the first side wall and the second side wall may be formed in one piece from a single component. The housing thus essentially forms a trapezoidal cuboid and is relatively easy to manufacture due to the flat housing walls.

The side walls and, if provided, the cover are made of aluminium so that the weight of the housing may be kept comparatively low. The side walls and/or the cover may also be made of plastic. Compared to plastic, however, aluminium has the advantage that there is no risk of molecular contamination from vapours released from the housing, which may otherwise pollute the air flowing through the filter fan unit.

The angle between the air inlet plane or the cover located in the air inlet plane and the first side wall may be about 95° to about 105°. In an embodiment, the angle is about 98° to about 102°.

Unless otherwise stated, the explanations regarding the first side wall also apply analogously to the second side wall. Thus, the angle between the air inlet plane and the second side wall may also be about 95° to about 105°, for example about 98° to about 102°. Although the axial symmetry described above is a feature of an embodiment, the first side wall and the second side wall may differ from each other in terms of shape, orientation and arrangement. For example, the angle between the air inlet plane and the first side wall may be different from the angle between the air inlet plane and the second side wall.

The fan may be a radial fan, whereby an axis of rotation of the radial fan may be aligned perpendicular to the air inlet plane or to the cover of the housing. The air flow out of the radial fan is perpendicular to the axis of rotation.

The housing may have a third side wall and a fourth side wall opposite the third side wall which extend at a right angle from the air inlet plane. This results in a simple structure and simple manufacture of the housing. The right angles of the third side wall and the fourth side wall allow space for air exiting the fan to flow without restriction or with reduced restriction, thereby reducing air turbulence and noise emission. In one embodiment, the third side wall, cover and fourth side wall are made from a single piece of sheet metal. Other alternatives are also envisioned. For example, the cover, the first side wall, the second side wall, the third side wall and/or the fourth side wall may be made from a single piece of sheet metal.

In an embodiment, the perforated plate extends to the third side wall and is attached to this third side wall. The perforated plate may also extend to the fourth side wall and also be attached to this fourth side wall. In contrast to the first side wall and the second side wall, there is therefore no gap between the perforated plate and the third side wall and/or between the perforated plate and the fourth side wall. This allows attachment of the perforated plate to the housing.

The plate may have an outer region and an inner region, wherein a permeability of an outer region, which corresponds to a ratio of a cumulative area of all openings to a total area of the outer region, is different from a permeability of the inner region. In other words, the plate has different regions through which more or less volume of the air flows. The different regions of the plate may provide more or less flow resistance. The perforated plate may be referred to as an air flow guide. Because the fan may not feed air into the filter uniformly, the different permeabilities of the plate, the gap between the first side wall and the first end edge of the plate and the gap between the second side wall and the second end edge of the plate allows the achievement of a very uniform flow through the filter in a relatively easy manner.

In one embodiment, the outer region has a greater permeability than the inner region. When the fan is a radial fan, air may exit the fan away from the axis of its motor. A greater volume and/or velocity of air may therefore be provided around the periphery of the fan. The outer region of the plate may be arranged to receive this greater volume of air. As air exiting the fan may bounce off the walls of the housing, the region next to the walls of the housing may receive air that has a lower velocity as compared to a region further away from the walls of the housing. Thus, high and low velocity areas result throughout the filter fan unit. The gap between the first side wall and the first end edge of the plate and the gap between the second side wall and the second end edge of the plate allow this air to be fed into the filter without resistance or with less resistance. The inner region of the plate may be arranged below the motor of the fan and may therefore receive a lower volume as well as a lower velocity of air. Greater permeability may be achieved by a greater density of openings (number of openings per unit area) and/or by a larger area per opening. For example, the openings are circular. The openings may also have a different shape (e.g., oval, slotted, square).

The outer region of the perforated plate may completely enclose the inner region. If the perforated plate has a rectangular base form, the outer region may extend over the entire base form with the exception of the inner region. In this case, the outer boundary of the outer region would also be rectangular. The inner region, which may also be rectangular or have a different shape (round, oval, polygonal), is then located within the outer region.

The perforated plate may have a baffle on the first end edge facing the first side wall which is angled in the direction of the filter. Typically the baffle is not perforated and directs air that hits the baffle towards the gap between the first end edge and the first side wall. This baffle intensifies the flow through the gap and leads to a greater flow to the region of the filter directly behind the gap.

An angle between the baffle and a plate plane of the perforated plate may be about 120° to about 150°. In one embodiment, the angle is about 125° to about 135°.

A baffle may also be arranged on the second end edge. The orientation and design of this baffle may correspond to the orientation and design of the baffle at the first end edge.

In one embodiment, the plate has at least one material cutout that is inclined in the direction of the fan. The material cutout may be provided at the inner region of the plate. The material cutout may guide air into the inner region, thereby providing more air flow to the corresponding part of the filter downstream of the plate. This material cutout allows the flow through the plate to be additionally influenced in order to achieve a uniform flow through the filter downstream of the plate.

An inner side of the first side wall may be provided with an acoustic foam material. The acoustic foam is open-pored so that sound waves may penetrate the material and effective sound absorption is possible. The acoustic foam may have a pyramid-shaped surface, which also ensures good sound absorption.

The second side wall may also be provided with the acoustic foam material. In one embodiment, the third side wall and the fourth side wall are not provided with the acoustic foam material, which simplifies the assembly and installation of the filter fan unit.

A pre-filter may be provided upstream of the fan. The pre-filter may be attached to the cover of the housing. The pre-filter may comprise a particle filter medium, such as those disclosed above. The pre-filter may alternatively or additionally comprise a molecular filter medium or an adsorbent, such as an activated carbon filter medium or a zeolite. The pre-filter may comprise a combination of different filter media. The pre-filter may comprise a filter medium that filters coarser particles as compared to the filter disclosed above.

The filter fan unit described hereinabove and hereafter may be used in a ceiling system for clean rooms.

### BRIEF DESCRIPTION OF DRAWINGS

The invention is explained in more detail with reference to embodiments shown in the drawings, wherein:

FIG. 1 shows a schematic sectional view of a filter fan unit according to the invention;

FIG. 2 shows a perspective view of the filter fan unit;

FIG. 3 shows a cut-away half of the filter fan unit; and

FIG. 4 shows a perforated plate for the filter fan unit in two different views, FIG. 4A and FIG. 4B.

### DETAILED DESCRIPTION

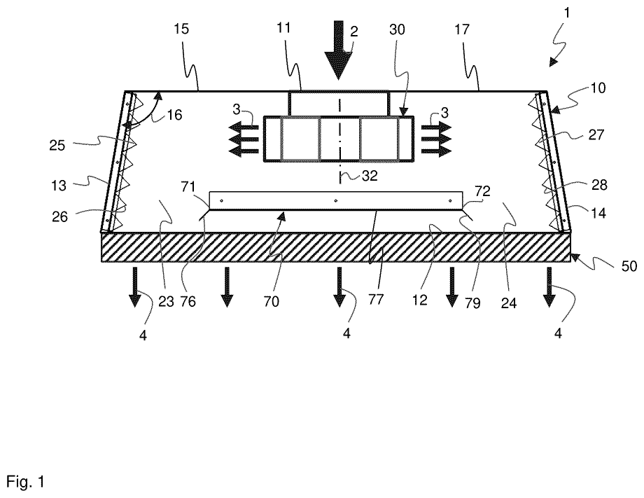

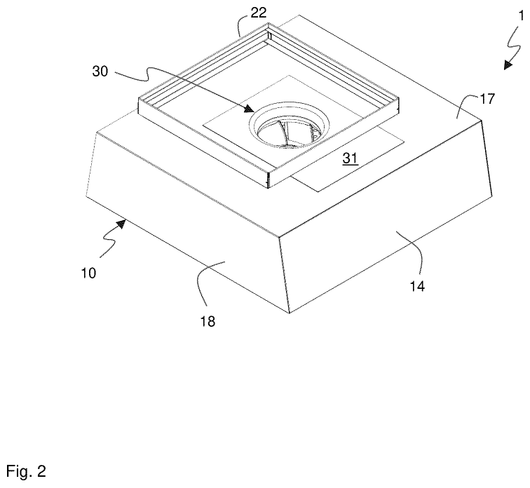

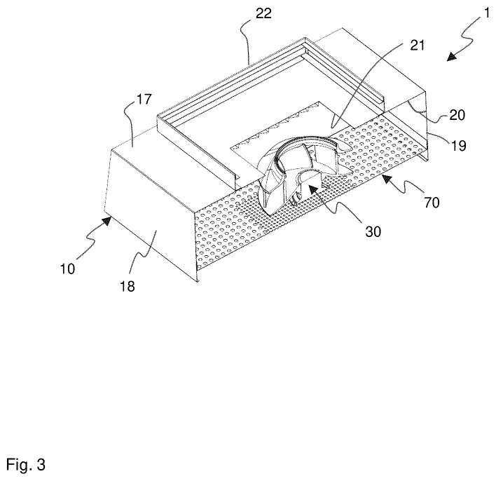

FIGS. 1 to 3 show a filter fan unit 1 in its entirety. FIG. 1 shows the filter fan unit 1 schematically in longitudinal section. FIGS. 2 and 3 show the filter fan unit 1 in a perspective view, whereby one half of the filter housing unit 1 is cut away in FIG. 3.

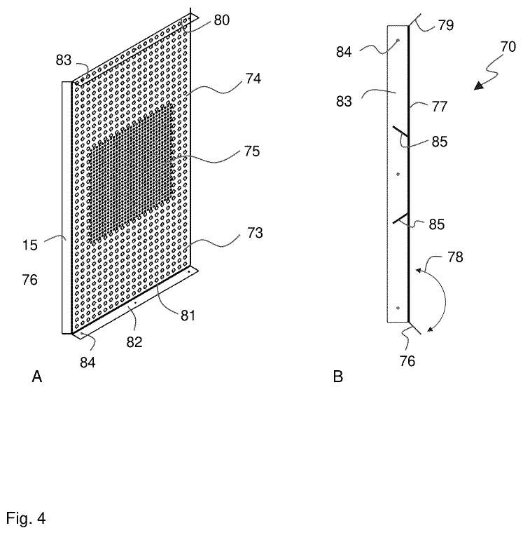

The filter fan unit 1 comprises a housing 10 and a fan 30 which is arranged in the housing 10. The fan 30 is a centrifugal fan and is shown only schematically in FIG. 1. Furthermore, the filter fan unit 1 comprises a filter 50 and a perforated plate 70 which is also arranged in the housing 10. The perforated plate 70 is shown alone in FIG. 4.

The fan 30 generates an air flow in the housing 10 from an air inlet 11 to an air outlet 12 of the housing 10. The filter 50, which may be a HEPA filter and is only shown in FIG. 1, is arranged at the air outlet 12.

The housing 10 has a first side wall 13 and a second side wall 14 which is opposite the first side wall 13 (see FIG. 1). The first side wall 13 and the second side wall 14 extend from an air inlet plane 15 to the air outlet 12. An angle 16 between the air inlet plane 15 and the first side wall is greater than 90° and is about 100° in the embodiment illustrated in FIG. 1. A corresponding angle between the air inlet plane 15 and the second side wall 14 is also about 100°.

A cover 17 of the housing 10, which connects the two side walls 13 and 14, is located in the air inlet plane 15. The housing 10 also has a third side wall 18 and a fourth side wall 19 opposite the third side wall 18 (see FIGS. 2 and 3). The fourth side wall 19 extends at a right angle (about 90°) from the air inlet plane 15 or from the cover 17. The corresponding angle is labelled 20 in FIG. 3. The third side wall 18 is also perpendicular (about 90°) to the cover 17.

An opening 21 is provided in the cover 17, into which the fan 30 may be inserted. As may be seen in FIG. 2, the fan 30 has a support plate 31 which is larger than the opening 21. In the installed position of the fan 30, the support plate 31 rests on the cover 17 or on the edge of the opening 21. A seal, not shown here, may be provided between the support plate 31 and the edge of the opening 21.

A rectangular frame 22 is attached to the cover 17 which serves to hold a pre-filter (not shown). The frame 22 is shown in FIGS. 2 and 3, but not in FIG. 1.

As shown schematically in FIG. 1, the fan 30 draws in air through the air inlet 11. The air is drawn in substantially parallel to the arrow 2 and parallel to an axis of rotation 32 of the fan 30. The air drawn in by the fan 30 leaves the fan 30 in a radial direction (see arrows 3) in the direction of the side walls 13, 14, 18, 19.

FIG. 1 also shows that a first end edge 71 of the perforated plate 70 and the first side wall 13 are spaced apart. A gap or free space 23 thus remains between the first end edge 71 and the first side wall 13, through which the air emerging from the fan 30 may reach the filter 50. A corresponding gap or free space between the second end edge 72 and the second side wall 14 is labelled 24 in FIG. 1. The air also passes through this free space 24 from the fan 30 to the filter 50.

In the embodiment shown here, the distance between the first side wall 13 and the first end edge 71 of the plate 70 is as large as the distance between the second side wall 14 and the second end edge 72 of the plate 70.

The sum of the distances may be about 40% to about 100% of the length of the plate 70 (the distance between the end edges 71, 72). In one embodiment, the sum of the distances is about 70% to about 90% of the length of the plate 70, with equal distances between the side walls 13, 14 and the respective end edges 71, 72. Uniform distribution of air volume and air velocities may be achieved across the filter fan unit 1 and the filter 50.

A portion of the air from the fan 30 flows through the plate 70, more specifically through a plurality of openings 73 provided in the plate 70 (see FIG. 4A). The plate 70 has a rectangular base, with the openings 73 distributed over the entire base. The plate 70 has an outer region 74 which completely encloses an inner region 75. The openings 73 in the outer region 74 are larger than the openings 73 in the inner region 75. Due to the free spaces 23, 24 and the plate 70 with its regions 74, 75, the flow is almost uniform across the entire surface of the filter 50, which is indicated by the arrows 4 in FIG. 1. This means that the filter 50 is optimally utilized. Optimum utilization of the filter 50 means that the power of the fan 30 and thus the speed at which the air exits the fan 30 may be reduced. This results in less noise and lower energy consumption.

The plate 70 has a baffle 76 at the first end edge 71, which is inclined in the direction of the filter 50 when the plate 70 is in the installed position. Air that hits the baffle 76 is thus increasingly channelled into the region of the air filter 50 which is located below the free space 23. An angle 78 between a plate plane 77 of the plate 70 and the baffle 76 is about 135° in the embodiment shown here (see FIG. 4B). A baffle 79 is also provided at the second end edge 72, which, like the baffle 76, is inclined at an angle of about 135° in the direction of the filter 50.

Angled webs 82, 83 are provided at transverse edges 80, 81 extending perpendicularly (about 90°) to the edges 71, 72, wherein the webs 82, 83 serve to fasten the plate 70 to the third side wall 18 and to the fourth side wall 19, respectively. The webs 82, 83 have holes 84 through which screws or similar fastening means may be passed in order to firmly connect the plate 70 to the housing 10. In contrast to the edges 71, 72 and the opposing side walls 13, 14, there is no gap or free space between the transverse edges 80, 81 and the side walls 18, 19, respectively.

FIG. 4B shows two material cutouts 85 which are inclined in the opposite direction to the baffles 76, 79, i.e., in this case in the direction of the fan 30. The material cut outs 85 provide additional openings in the plate 70 so that the flow through the plate 70 is increased. In addition, similar to the baffles 76, 79, the material cutouts 85 specifically influence the flow towards the filter 50 with the aim of achieving a uniform flow through the filter 50. The material cutouts 85 guide the flow into a region of the plate 70 that may otherwise receive a lower volume of air, such as the inner region 75 of the plate 70. The material cutouts 85 may extend from a periphery of the inner region 75. The material cutouts 85 may extend from the plate 70 at an incline, thereby guiding the air flow into the inner region 75. An angle between the plate plane 77 and the material cutout is about 30° to about 60°, for example about 30° to about 45°. The material cutouts 85 are not shown in the other figures.

To reduce the noise emission of the filter fan unit 1, an inner side of the first side wall 13 is provided or equipped with an acoustic foam 25. The acoustic foam 25 has a pyramid-shaped surface 26. The second side wall 14 is also provided or equipped with an acoustic foam material 27 which also has a pyramid-shaped surface 28.

### REFERENCE NUMBERS

1 filter fan unit
2 air flow/arrow
3 air flow/arrow
4 air flow/arrow
10 housing
11 air inlet
12 air outlet
13 first side wall
14 second side wall
15 air inlet plane
16 angle
17 cover
18 third side wall
19 fourth side wall
20 angle
21 opening
22 frame for pre-filter
23 gap/free space
24 gap/free space
25 acoustic foam
26 pyramid-shaped surface
27 acoustic foam
28 pyramid-shaped surface
30 fan
31 support plate
32 rotation axis
50 filter
70 plate
71 first end edge
72 second end edge
73 openings
74 outer region
75 inner region
76 baffle
77 plate plane
79 baffle
80 transverse edge
81 transverse edge
82 angled web
83 angled web
84 holes
85 material cutout

1. A filter fan unit comprising:
a housing;
a fan arranged in the housing and configured to generate an air flow from an air inlet to an air outlet of the housing; and
a filter arranged at the air outlet,
wherein the housing has an opening for the fan and side walls extending from an air inlet plane, in which the opening is located, in the direction of the air outlet;
wherein an angle between a first side wall and the air inlet plane and an angle between a second side wall opposite the first side wall and the air inlet plane is each greater than 90° so that the first side wall and the second side wall diverge in the direction of the air outlet;
wherein a perforated plate is disposed between the fan and the air outlet and extends substantially parallel to the air inlet plane;
wherein a first end edge of the plate and the first side wall are spaced apart and a second end edge of the plate and the second side wall are spaced apart.

2. The filter fan unit according to claim 1, wherein the housing has a cover which lies in the air inlet plane and delimits the opening for the fan.

3. The filter fan unit according to claim 1, wherein the angle between the air inlet plane and the first side wall is about 95° to about 105°.

4. The filter housing unit according to claim 1, wherein the fan is a radial fan, and wherein an axis of rotation of the radial fan is aligned perpendicular to the air inlet plane.

5. The filter fan unit according to claim 1, wherein the housing has a third side wall and a fourth side wall opposite the third side wall which each extend at a right angle from the air inlet plane.

6. The filter fan unit according to claim 1, wherein the perforated plate extends to the third side wall and is attached to the third side wall.

7. The filter fan unit according to claim 1, wherein the plate has an outer region and an inner region, and wherein a permeability of the outer region is different from a permeability of the inner region.

8. The filter fan unit according to claim 7, wherein the outer region completely encloses the inner region.

9. The filter fan unit according to claim 1, wherein the perforated plate has a baffle angled in the direction of the filter at the first end edge facing the first side wall.

10. The filter fan unit according to claim 9, wherein an angle between the baffle and a plate plane of the perforated plate is about 120° to about 150°.

11. The filter fan unit according to claim 1, wherein the perforated plate has at least one material cutout which is inclined in the direction of the fan.

12. The filter fan unit according to claim 1, wherein an inner side of the first side wall is provided with an acoustic foam.

13. The filter fan unit according to claim 12, wherein the acoustic foam has a pyramid-shaped surface.

14. The filter fan unit according to claim 1, wherein a pre-filter is provided upstream of the fan.
